(19) United States
(12) Patent Application Publication
(10) Pub. No.: US 2002/0122558 A1
(43) Pub. Date: Sep. 5, 2002

(54) Magnetic circuit for an electrodynamic loudspeaker

(76) Inventor: Philippe Lesage, Dammarie Les Lys (FR)

Correspondence Address: STEVENS, DAVIS, MILLER & MOSHER, L.L.P., 1615 L. Street, N.W., Suite 850, Washington, DC, 20036, US

(21) Appl. No.: 10/083,407

(22) Filed: Feb. 27, 2002

(30) Foreign Application Priority Data
Mar. 1, 2001 (FR) 01 02807

(51) Int. Cl. H04R 3/00

(52) U.S. Cl. 381/117; 381/396; 381/400

(57) ABSTRACT

According to the invention, this magnetic circuit, of known type with a central magnet, is such that the diameter of said central magnet 8.1 is greater than that of the core 9.1, such that said magnet 8.1 has a peripheral projection 14, which is annular and radial, with respect to the core 9.1. The performance of said magnet is thus improved.

The present invention relates to magnetic circuits for electrodynamic loudspeakers, and to such loudspeakers comprising these magnetic circuits.

Many magnetic circuit structures for an electromagnetic loudspeaker are known. Among these known structures, the one referred to as “with a central magnet” is particularly advantageous with regard to the magnetic energy to be supplied by the magnet, which may be only 1.6 times greater than that required in the gap in order to displace the moveable coil axially, and very low magnetic leakage. The latter property therefore makes it possible to use the loudspeaker provided with a magnetic circuit with a central magnet close to equipment sensitive to magnetic fields, such as video monitors, computers, instruments on board aircraft, etc.

Because of their noteworthy energy performance, magnetic circuits with a central magnet may be, for equal power, of smaller size than, for example, magnetic circuits with an annular magnet, and this even more so when said magnet, if made from a high-energy material, such as that containing rare earths, may itself be of small size. By way of example of such high-energy magnets, mention may be made of those made of a sintered neodymium-iron-boron terniary alloy.

It will be recalled that a modern magnetic circuit of the “central magnet” type for an electrodynamic loudspeaker has a shape which is axisymmetric about an axis of symmetry and comprises:

a dish-shaped yoke with a flat bottom, whose edge, away from said bottom, is provided with a peripheral annular rim projecting toward said axis with respect to the side wall of said dish and defining a circular opening which is recessed with respect to said side wall;

a disk-shaped magnet, placed centrally inside said yoke and borne by said flat bottom thereof; and

a cylindrical core, placed centrally inside said yoke and borne by said magnet, the part of said core away from said magnet being opposite said circular opening of the yoke and defining, with the latter, an annular gap, in which said moving coil is placed coaxially with the axis of said magnetic circuit thereby being able to move parallel to and coaxially with said axis, the clearance height available for the coil inside said yoke being greater than the maximum distance that said coil can travel inside said yoke, toward the bottom thereof.

In known magnetic circuits of this type, the diameter of said magnet is equal to that of the core, such that the clearance height for the coil may be determined by the sum of the heights of the core and of the central magnet. This results in a limit to the area of the magnet and therefore to the high performance of these known magnetic circuits. This is because, if it is required to increase the energy of the magnet, the only option is to increase its thickness, which at the same time leads to increasing its internal reluctance, and therefore to limiting the performance of the magnetic circuit.

The object of the present invention is to overcome these drawbacks by improving the magnetic circuits with a central magnet in order to further increase the performance thereof by reducing the internal reluctance thereof.

To this end, according to the invention, the magnetic circuit with a central magnet for an electrodynamic loudspeaker having the structure summarized above, is noteworthy in that:

the diameter of said magnet is greater than that of said core, such that said magnet has a peripheral projection, which is annular and radial, with respect to said core; and

the clearance height for the coil is limited, on the side facing said magnet, by said peripheral projection, such that this clearance height is determined solely by said core.

Thus, by virtue of the present invention, the diameter of the magnet may be chosen in order to attain, for an identical gap, a performance greater than that of the prior art. This is because, in order to increase the performance of a magnetic circuit, it is preferable to increase the area of the magnet by increasing its diameter rather than by increasing its thickness, the reluctance of a disk-shaped magnet being proportional to its height and inversely proportional to its area.

Of course, with equal clearance for the moving coil, the structure according to the present invention leads to an increase in the height of the coil and of the yoke, and possibly to an increase in the diameter of said yoke. However, these size increases—of small magnitude—allow the magnetic circuit of the invention in particular to exceed the already high performance of known magnetic circuits, summarized above.

Experience and calculations have shown that a considerable increase in performance could already be obtained when the peripheral radial projection of the magnet with respect to the core was at the most equal to three times the thickness of said magnet, for example of the order of one or two times this thickness.

In order to further lower the internal reluctance of said magnet, and therefore to increase the performance of said magnetic circuit, the latter may, in addition, be such that:

said core comprises, in contact with said magnet, a disk-shaped projecting heel, the diameter of which is greater than that of the rest of said core, but smaller than that of said magnet; and

the clearance height for the coil is limited, on the side facing said magnet, by said projecting heel.

Here again, the increases in performance which result from a structure of this sort very fully justify the inherent dimension increases.

Where the loudspeaker comprising the magnetic circuit according to the present invention is of high power, requiring ventilation for cooling the core, or else is of the coaxial type requiring a central conduit, said magnetic circuit is provided with an axial passage passing through said flat bottom of the yoke, said magnet and said core.

It will be noted that an axial passage of this sort is possible, by virtue of the invention, because the cross section of the magnet can be chosen to be large enough, by virtue of the peripheral projection of said magnet, to compensate for the loss of magnetic material resulting from said passage.

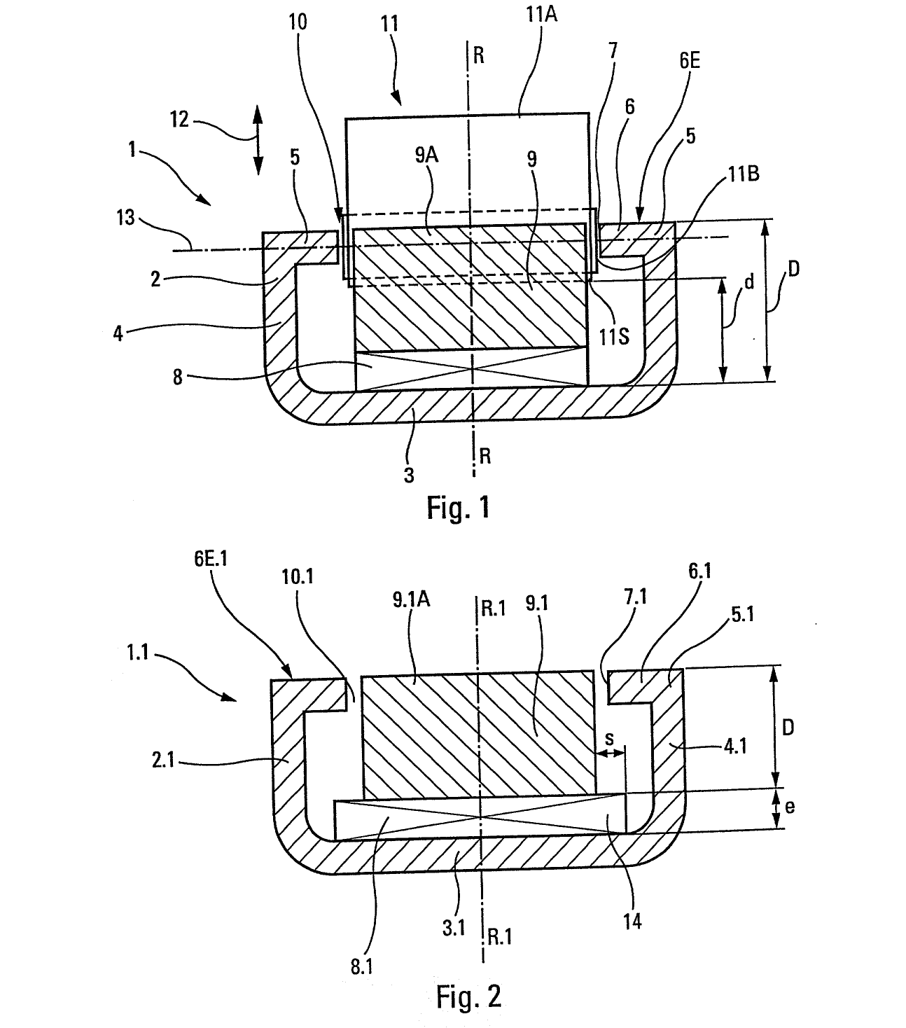

The figures of the appended drawing will make it easier to understand how the invention can be embodied. In these figures, the elements of FIGS. 2, 3 and 4 which are similar to elements of FIG. 1 bear the same reference as the latter, but allocated with a specific index.

FIG. 1 illustrates, in a schematic axial section, a known magnetic circuit, of the type with a central magnet, intended for an electrodynamic loudspeaker.

FIGS. 2, 3 and 4 illustrate, in schematic axial section, three embodiments of the magnetic circuit according to the present invention.

For the purposes of comparison, the magnetic circuits of FIGS. 1 through 4 have identical gaps, and coil clearance heights which are also identical.

The magnetic circuit 1 for an electrodynamic loudspeaker, of known type and shown in FIG. 1, has a shape which is axisymmetric about an axis R-R. The magnetic circuit 1 comprises:

a dish-shaped yoke 2 which is axisymmetric about the axis R-R, for example, made of soft steel, comprising a flat bottom 3 and a cylindrical side wall 4. On the side away from the bottom 3, the edge 5 of the wall 4 is provided with a peripheral annular rim 6 projecting, toward said axis of revolution R-R, with respect to the side wall 4. The annular rim 6 defines a circular opening 7, centered on the axis of revolution R-R and recessed with respect to the side wall 4;

a disk-shaped magnet 8, placed inside the yoke 2, coaxially with the axis of revolution R-R and borne by the flat bottom 3 of the yoke 2. The magnet 8 consists, for example, of a sintered neodymium-iron-boron ternary alloy; and

a cylindrical core 9, for example made of soft steel, placed inside the yoke 2, coaxially with the axis of revolution R-R, and borne by said magnet 8. The part 9A of the core 9, away from the magnet 8, is opposite the circular opening 7 of the yoke 2 and defines therewith an annular gap 10.

Moreover, in a known manner, the electrodynamic loudspeaker comprising the magnetic circuit 1 comprises a moving coil 11, consisting of a cylindrical support 11A surrounding the core 9 and made of a rigid, electrically nonconducting and heat-resistant material, and of a helical winding 11B borne by the cylindrical wall of said support 11A. The winding 11B is bonded structurally onto the support 11A, and the assembly 11A-11B is placed coaxially with the axis of revolution R-R.

The winding 11B is placed inside the gap 10 and the coil 11 can move parallel to and coaxially with said axis of revolution R-R, as is illustrated schematically by the double arrow 12.

The coil 11 is, in a known manner (not shown), secured to the membrane of the loudspeaker (not shown) and to its suspensions which are the spider and the peripheral edge of the cone (also not shown) and which only allow said coil to move axially while preventing any lateral displacement which would risk leading to the coil 11B rubbing against the edge of the opening 7.

At rest, the axial position of the coil 11 is such that the median plane 13 of the gap 10 (orthogonal to the axis R-R) passes through the middle of the winding 11B, as is shown in FIG. 1. Of course, the winding 11B is subjected to the magnetic field in the gap 10, such that, when a modulation current flows through the winding, the coil 11 moves along the axis of revolution R-R.

In the magnetic circuit 1, known and shown in FIG. 1, the magnet 8 has a diameter identical to that of the coil 9, such that the cylindrical walls of said magnet and of said core are in line with each other. Subsequently, in the rest position of the coil 11, the edge 11S thereof, placed on the side facing the bottom 3, is opposite said bottom 3 and is separated therefrom by a distance d, representing the height available for the displacement of the coil inside the yoke 2. Of course, in order to avoid the coil 11 striking the bottom 3 and risking being destroyed thereby, this distance d is determined so as to be greater than the maximum travel that the coil 11 can move, inside the yoke 2, in the direction of the bottom 3.

It will be noted that, for a given coil 11, the distance D separating the bottom 3 from the outer face 6E of the annular rim 6 is representative of the distance d, meaning the available height.

FIG. 2 shows a first embodiment 1.1 of the magnetic circuit for an electrodynamic loudspeaker according to the present invention. For purposes of simplification, the coil 11 has not been shown. Moreover, each element of FIG. 2, which corresponds to an element 2 to 10 of FIG. 1, bears the same reference number, to which the index 1 is assigned.

In the magnetic circuit 1.1, the diameter of the magnet 8.1 is greater than that of the core 9.1 and forms an annular and radial peripheral projection 14, of radial magnitude s, with respect to said core 9.1. The radial magnitude s of the projection 14 is, in the example shown in FIG. 2, of the order of the thickness e of the magnet 8.1. More generally, this radial amplitude s could be at the most equal to three times the thickness e.

It can be seen that, in the magnetic circuit 1.1, the clearance height D for the coil is limited, on the side facing the magnet 8.1, by the peripheral projection 14. The coil 11 therefore only moves opposite the core 9.1.

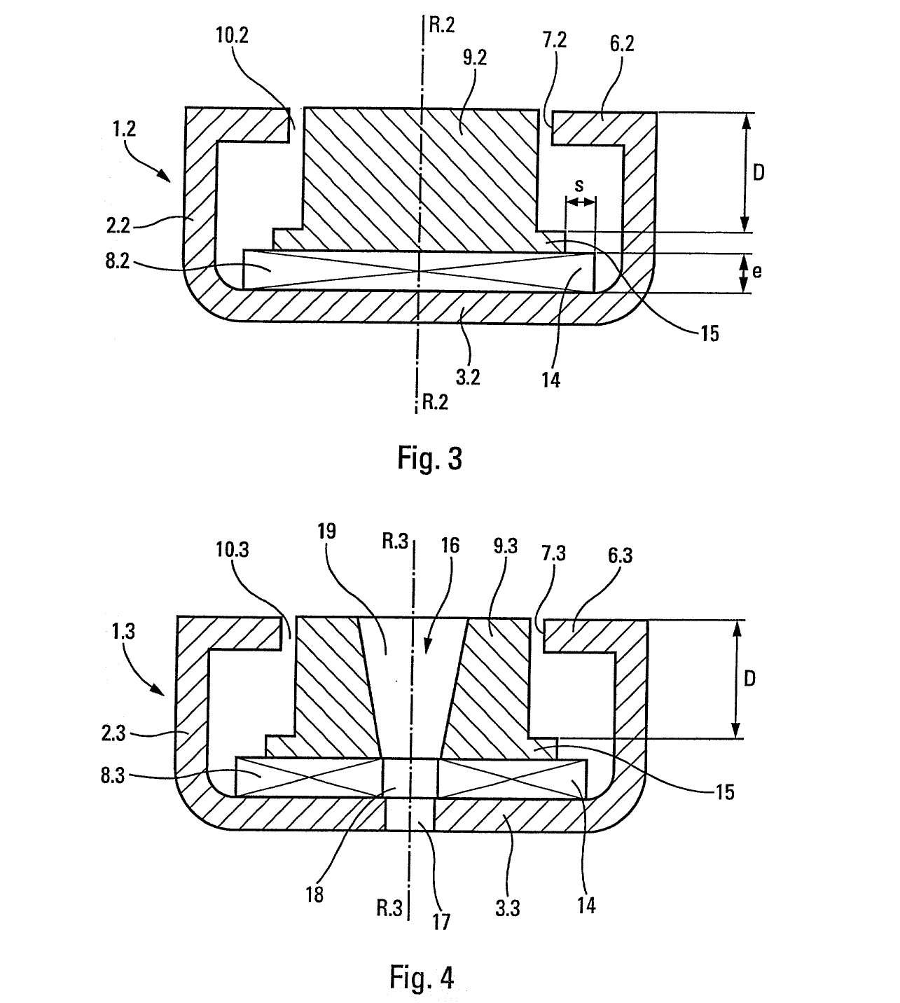

In the variant embodiment 1.2 of the magnetic circuit according to the present invention, illustrated schematically in FIG. 3, there is a yoke 2.2 and a magnet 8.2, similar or identical to the yoke 2.1 and to the magnet 8.1, respectively, of FIG. 2.

The core 9.2 of the magnetic circuit 1.2 differs from the core 9.1 of the magnetic circuit 1.1 in that it comprises, on the side facing said magnet 8.2, a disk-shaped projecting heel 15, the diameter of which is greater than that of the rest of the core 9.2, but smaller than that of the magnet 8.2, the latter also forming the peripheral projection 14, which is annular and radial, with respect to the periphery of the heel 15.

The magnetic circuit 1.3 of FIG. 4 comprises a yoke 2.3, a magnet 8.3 and a core 9.3 similar to the corresponding elements 2.2, 8.2 and 9.2 of the magnetic circuit 1.2.

The only difference is that, around the axis R3-R3, a passage 16 is provided passing axially through said magnetic circuit 1.3 and consisting of a series of holes 17, 18 and 19, made in the flat bottom 3.3, the magnet 8.3 and the core 9.3, respectively.

Preferably, the magnets 8.1, 8.2 and 8.3 are made of a sintered neodymium-iron-boron ternary alloy.

In the above description, it will be easily understood that, by virtue of the present invention, particularly high-performance magnetic circuits are obtained, even for small core diameters 9.1, 9.2 and 9.3. Thus, electrodynamic loudspeakers incorporating these magnetic circuits may themselves have a high performance.

1. A magnetic circuit (1.1, 1.2, 1.3) for an electrodynamic loudspeaker with a moving coil, said magnetic circuit having a shape which is axisymmetric about an axis of symmetry (R1-R1; R2-R2; R3-R3) and comprising:
a dish-shaped yoke (2.1; 2.2; 2.3) with a flat bottom, whose edge, away from said bottom, is provided with a peripheral annular rim (6.1; 6.2; 6.3) projecting toward said axis with respect to the side wall of said dish and defining a circular opening (7.1; 7.2; 7.3) which is recessed with respect to said side wall;
a disk-shaped magnet (8.1; 8.2; 8.3), placed centrally inside said yoke and borne by said flat bottom (3.1; 3.2; 3.3) thereof; and
a cylindrical core (9.1; 9.2; 9.3), placed centrally inside said yoke and borne by said magnet, the part of said core away from said magnet being opposite said circular opening of the yoke and defining, with the latter, an annular gap (10.1; 10.2; 10.3), in which said moving coil is placed coaxially with the axis of said magnetic circuit thereby being able to move parallel to and coaxially with said axis, the clearance height (D) available for the coil inside said yoke being greater than the maximum distance that said coil can travel, inside said yoke, toward the bottom thereof, wherein:
the diameter of said magnet (8.1; 8.2; 8.3) is greater than that of said core (9.1; 9.2; 9.3), such that said magnet has a peripheral projection (14), which is annular and radial, with respect to said core; and
the clearance height for the coil is limited, on the side facing said magnet, by said peripheral projection, such that this clearance height is determined solely by said core.

2. The magnetic circuit as claimed in claim 1, wherein the peripheral radial projection (14) of the magnet with respect to the core is at the most equal to three times the thickness (e) of said magnet.

3. The magnetic circuit as claimed in claim 2, wherein the peripheral radial projection (14) of the magnet with respect to the core is about the thickness of said magnet.

4. The magnetic circuit as claimed in claim 1, wherein:
said core comprises, in contact with said magnet, a disk-shaped projecting heel (15), the diameter of which is greater than that of the rest of said core (9.2; 9.3), but smaller than that of said magnet (8.2; 8.3); and
the clearance height for the coil is limited, on the side facing said magnet, by said projecting heel (15).

5. The magnetic circuit as claimed in claim 1, wherein it comprises an axial passage (16) passing through the flat bottom (3.3) of said yoke (2.3), said magnet (8.3) and said core (9.3).

6. The magnetic circuit as claimed in claim 1, wherein said magnet (8.1; 8.2; 8.3) is made of a sintered neodymium-iron-boron ternary alloy.

7. An electrodynamic loudspeaker, which comprises a magnetic circuit (1.1; 1.2; 1.3) as specified in claim 1.
